(19) United States
(12) Patent Application Publication
(10) Pub. No.: US 2006/0155622 A1
(43) Pub. Date: Jul. 13, 2006

(54) System and method for enhancing the return of an asset accumulation product

(75) Inventor: Robert Laux, Hong Kong (CN)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: American International Group, New York, NY (US)

(21) Appl. No.: 11/030,806

(22) Filed: Jan. 7, 2005

(51) Int. Cl. G06Q 40/00

(52) U.S. Cl. 705/35

(57) ABSTRACT

A system and method for allowing an individual to accumulate wealth faster in the event of an adverse personal consequence, such as a death, a disabling accident or a critical illness. The system and method includes issuing an asset accumulation product and an insurance rider that guarantees an increase in the yield of the asset accumulation product upon the occurrence of an adverse personal event.

### FIELD OF THE INVENTION

The present invention enhances the return or yield of an asset accumulation investment upon the occurrence of an adverse personal event, such as an accidental death, dismemberment or disability.

### BACKGROUND OF THE INVENTION

Asset accumulation products, such as annuities or other savings products, are typically contracts between an individual and a financial company, such an insurance company, which contracts are designed to provide payments to the individual at specified intervals. The financial company guarantees a payment or payments in exchange for an investment by the individual in the form of a premium or premiums. The investor ordinarily expects that the return payments will exceed the premiums paid by the individual.

As is known in the art, the return or yield on an asset accumulation product can be variable or fixed. In addition, the return or yield may be deferred or paid immediately. If payments are deferred, the financial company begins payment of benefits at a maturity date. The internal rate of return of an asset accumulation product, such as an annuity, over its entire investment horizon is also known as the yield to maturity. The return on an asset accumulation product at any given time is also known by various terms, including “crediting yield” or “crediting rate.” In this specification, the return or yield of an asset accumulation product shall be referenced by the term “base yield,” which shall be distinguished from the term “enhanced yield” or “enhanced rate.” Various factors can affect the yield of an asset accumulation product, including interest rates and the performance of various equity and bond markets.

Asset accumulation products may be advantageous to an individual investor when compared with other possible investments, particularly from a tax perspective. The investor is typically taxed in connection with the product only when the financial company makes payments or if the investor withdraws funds from the account. As such, the yield on an asset accumulation product is tax-deferred. Unlike other government qualified tax-deferred plans, however, the income used to fund the premiums for an asset accumulation product is typically not deductible from an individual's income tax. For this reason, however, governments typically do not impose income restrictions on the amount that may be placed in asset accumulation products. Asset accumulation products thus offer an additional opportunity for tax-deferred investing for individual investors with high incomes or who have reached their contribution limits in other government qualified tax-deferred plans.

In the past, financial companies offered and sold various insurance contacts, also known as “riders,” to individuals who purchased asset accumulation products. The most common form of these riders involved payment of a benefit in the event of an accidental death or dismemberment (AD&D rider) or disability (disability rider) of the individual. These riders were advantageous to those individuals or estates that might need immediate insurance benefits in the event of a covered loss.

FIG. 1 illustrates a conventional process for issuing an asset accumulation product with a conventional rider. In step 1, the financial company offers the asset accumulation product, which in decisional 2, is either accepted or declined. If an individual accepts the purchase, the financial company issues the product, as indicated by step 3. The financial company also might offer a conventional rider, as indicated in step 4. This rider, such as an AD&D rider, pays benefits that are independent of the yield of the asset accumulation product. An individual determines whether to accept or decline the conventional rider, as indicated by decisional 5. In the event that the individual accepts the rider offer, the financial company thereafter issues the conventional rider, step 6.

The benefits of a conventional rider, as noted above, do not relate to the yield of the asset accumulation product. Instead, a conventional rider, an AD&D rider for example, may pay a lump sum benefit, periodic payments, or both. These benefits are issued and administered separately from the underlying asset accumulation product. As such, the full benefit of a tax-deferred asset accumulation product may be lost.

Although the payment of immediate benefits under a conventional rider may be desirable in certain situations, such as when an individual needs to replace lost income, it is not desirable where the individual does not have an immediate need for the benefits. There is thus a need for a system and method that more effectively tailors the benefits of an asset accumulation rider to the investment goals and strategies of an individual.

### SUMMARY OF THE INVENTION

In a preferred embodiment of the invention, a financial company issues an underlying asset accumulation product (“product”) to an individual in exchange for payment of at least one premium. The product returns a certain yield (“base yield”) at its maturity. The financial company further offers an insurance rider, which if purchased, is attached to the product and guarantees an enhanced yield for the product upon the occurrence of a predetermined event. The rider premium is substantially lower than the premium or premiums for the product. In an embodiment of the invention, premium or premiums for the rider are paid along with the base policy premium, whether single or annual.

The base yield of the product may be fixed or variable, and the enhanced yield is determined as an increase to the base yield, which increase also may be fixed or variable. In a highly preferred embodiment, the increase to the base yield is determined by adding basis points to yield. The increase to the base yield may range, for example, from between three hundred to five hundred basis points. An exemplary base yield of 4 percent, therefore, will be enhanced to a yield ranging from between 7 percent to 8 percent upon the occurrence of a predetermined event. Rather than enhancing the yield by a fixed amount, the increase also may be determined as a variable amount.

In yet other embodiments of the invention, the insurance rider guarantees payment of a lump sum benefit upon the occurrence of the predetermined event. The invention, in this regard, duplicates, in whole or in part, the advantages of the conventional rider, but further provides for an enhanced yield of the product.

In preferred embodiments of the invention, the predetermined events that trigger an enhanced yield include commonly insurable events such as accidental death, dismemberment, serious illness, and/or the disability of an individual to perform an occupation. Certain events, such as preexisting conditions or bioterrorism, may be excluded from the rider.

As an incentive to purchase the rider, the financial company also may enhance the base yield of the product regardless of whether the predetermined event occurs. This automatic enhancement of the yield offsets the premiums paid for the rider. In a highly preferred embodiment, the automatic enhancement occurs only in the first year of the product's term. The automatic enhancement is substantially less than an enhancement based on a triggering event, and may range, for example, from between ten to sixty basis points. In yet other embodiments, the premium or premiums paid by the individual for the rider are returned to the individuals upon the occurrence of a triggering event.

Further objects, features and advantages of the invention will become apparent from the detailed description of the preferred embodiments that follows, particularly when considered in conjunction with the attached figures of drawing.

### BRIEF DESCRIPTION OF THE DRAWINGS

Exemplary embodiments of the invention are given below with reference to the drawings, in which:

FIG. 1 is a flowchart illustrating a prior art process of issuing an asset accumulation product and a conventional rider;

FIG. 2 is a flowchart illustrating the inventive process of issuing an asset accumulation product along with a yield-enhancing rider and/or a conventional rider; and

FIG. 3 illustrates a simplified example of an asset accumulation product that compares the yield of the product in various scenarios.

### DETAILED DESCRIPTION OF PREFERRED EMBODIMENTS

A method and product for enhancing the yield of an asset accumulation product is provided. The owner of the asset accumulation product, through use of the invention, is able to accumulate wealth faster in the event of an adverse personal consequence, such as a death, a disabling accident or a critical illness.

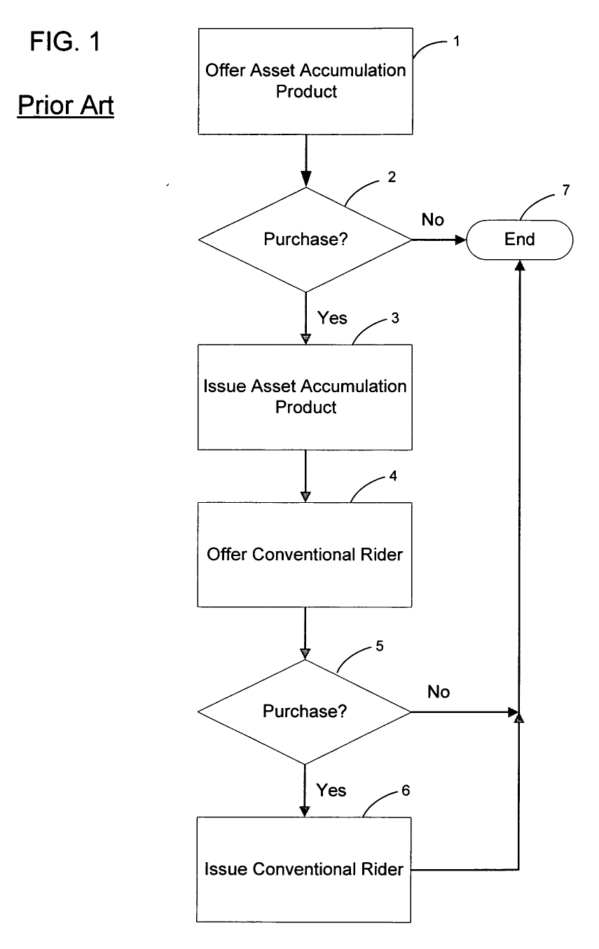

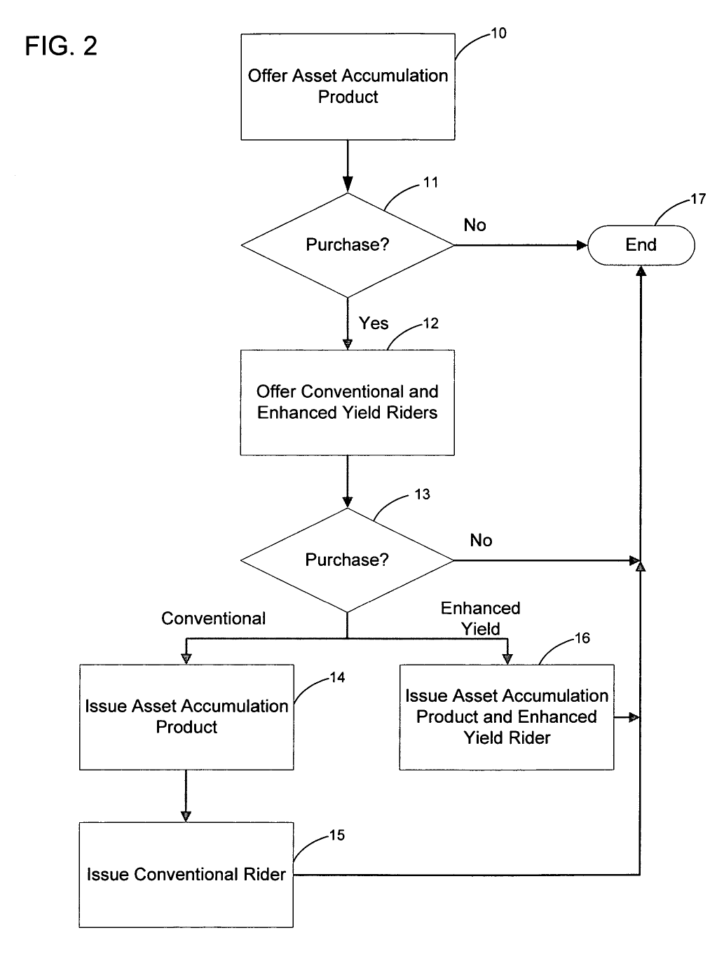

FIG. 2 illustrates the steps a financial company may undertake in order to implement a preferred embodiment of the invention. The flowchart of FIG. 2 may be contrasted with the steps of a conventional process as explained above and illustrated in FIG. 1. To begin the process, at step 10, the financial company offers an asset accumulation product (“product”) to an individual. This product be offered in different forms, including as an annuity. An individual who decides to purchase such a product, as indicated with a “yes” at decisional 11, is then offered an opportunity to purchase conventional riders, a yield-enhancing rider, or both, step 12. As is known from the prior art, a conventional rider offers an individual an immediate benefit or benefits upon the occurrence of certain predetermined events. The yield-enhancing rider, however, offers the individual an additional choice, namely, a benefit that is related to the yield of the underlying or “base” product.

For a variety of reasons, individuals may desire a conventional rider in connection with the purchase of an asset accumulation product. For example, an individual who was employed at the time of purchasing the product but subsequently becomes disabled, may need immediate income in order to forego terminating the product prior to maturity. Because an asset accumulation product, may involve a penalty or other disadvantage if the investment is withdrawn prior to maturity, the individual may find it worthwhile to purchase insurance to hedge against the possibility of a disabling event. Other individuals, however, may not have an immediate need for an insurance benefit upon the occurrence of the predetermined event. For these individuals, the yield-enhancing rider permits a more advantageous option that allows such an individual to accumulate wealth more rapidly than would be possible under the conventional rider.

The enhanced-yield rider permits an individual to hedge against predetermined events for which financial and insurance companies have long provided insurance. Insurance companies are practiced in the art of spreading of risk based upon actuarial data, and commonly provide insurance for events such as accidental death, dismemberment, serious illness, and/or the disability of an individual to perform an occupation. Consequently, the financial company may offer an enhanced-yield rider to an individual that is based on any of these insurable events (a “triggering event”). Likewise, certain events, such as preexisting conditions or bioterrorism, may be excluded from the enhanced-yield rider.

Upon an individual selecting a “conventional” rider, as illustrated at decisional 13, the financial company issues the asset accumulation product, step 14, and the conventional rider, step 15. The individual may also, or in the alternative, select an “enhanced yield” rider, as illustrated at decisional 13. In this event, the financial company issues the asset accumulation product and enhanced-yield rider, step 16.

Step 16 illustrates the process of issuing the asset accumulation product together with the enhanced-yield rider. This single step 16 may be contrasted with similar but separate steps in the conventional rider purchase, steps 14 and 15. Although illustrated as a single step in the enhanced yield process, it will be understood by persons of skill in the art that the rider and accumulation product are separate financial instruments. They are identified as single step 16 in the enhanced yield process, however, to conceptually illustrate that the enhanced-yield rider is more tightly integrated to the performance of the asset accumulation product than was previously known in the art.

The enhanced-yield rider, which is issued in step 16, is attached to the base product and guarantees an increase to the base yield of the product upon a triggering event. In preferred embodiments of the invention, the increase to the base yield is determined by adding predetermined basis points to the yield. In a highly preferred embodiment, the increase to the base yield ranges from between three hundred to five hundred basis points. As such, the increase is fixed, although the yield and enhanced yield may be variable. It is noted, however, that the invention does not require that increases to the yield be fixed. The increase may be variable and calculated from external factors, such as the London Interbank Offered Rate Index (LIBOR) or the performance of one or more investments.

As yet a further alternative, the increase to the base yield may be a variable amount that is calculated from an internal factor, such as the current crediting yield of the base product. As an example of this type of alternative, the increase to the base yield is a certain percentage of the base yield itself, such as twelve percent (12%). In such an example, a crediting yield of 4 percent will be enhanced to a yield of 4.48 percent, whereas a crediting yield of 3 percent will be enhanced to a yield of 3.36 percent.

The enhanced yield rider may also duplicate, in whole or in part, certain advantages of the conventional rider. For example, the enhanced yield rider may provide for the payment of a lump sum benefit to the individual upon the occurrence of the predetermined event. The financial company would pay this lump sum benefit in addition to increasing the yield of the product. The amount of the increase in the yield and/or the lump sum payment depends on the premiums paid by the individual and the risk category of the individual. A further optional benefit of the rider may waive any surrender charge associated with a withdrawal of funds from the product prior to maturity. By coupling at least a portion of the advantages of a conventional rider, such as a lump sum benefit, with the advantages of the enhanced yield rider, the invention offers yet a further improvement over the prior art.

The enhanced yield rider also may provide a benefit that is independent of a triggering event. In this inventive process, the financial company enhances the base yield of the product regardless of whether the predetermined event occurs. In one particularly preferred embodiment, the yield enhancement portion that is not dependent on a triggering event is offered only in the first year of the product's term. This automatic enhancement, however, is substantially less than an enhancement based on a predetermined event. In a preferred embodiment, the automatic enhancement ranges from between ten to sixty basis points.

As yet another embodiment within the scope of the invention, all of the premiums paid by the individual for the enhanced-yield rider are returned to the individuals upon the occurrence of the predetermined event. This incentive permits the financial company to market the enhanced-yield rider as essentially “free” insurance in the event of an adverse personal consequence.

In exchange for issuing the enhanced-yield rider, step 16, the financial company charges and receives a premium. The premiums are calculated in a way known to persons of skill in the art and depend on the type of event for which insurance via the rider is sought. Premiums may be differentiated, for example, on the basis of age at the time of issuance, the sex of the individual, and/or whether the individual has a history of smoking tobacco. Due to the low expected incidence of triggering events, it is anticipated that the rider premiums will be substantially lower than the base premiums, e.g., between one to two percent (1%-2%).

In the preferred embodiments of the invention, the rider premiums are paid and collected over the same period as the base product. The individual may thus make a single premium payment for the rider if a single premium is paid for the base product. As an alternative embodiment, however, the premiums for the enhanced-yield rider are separated from the base product. In this latter arrangement, the rider may be allowed to lapse independently from the base product.

In order to minimize the risks associated with the enhanced yield rider, a preferred embodiment of the invention contemplates a maximum term for the base plan, and consequently, a maximum term for the enhanced yield rider. In a highly preferred embodiment, this maximum term for both instruments is 10 years. Likewise in a preferred embodiment of the invention, the enhanced yield rider includes certain restrictions such as a minimum and maximum age, e.g., 16 and 59, respectively.

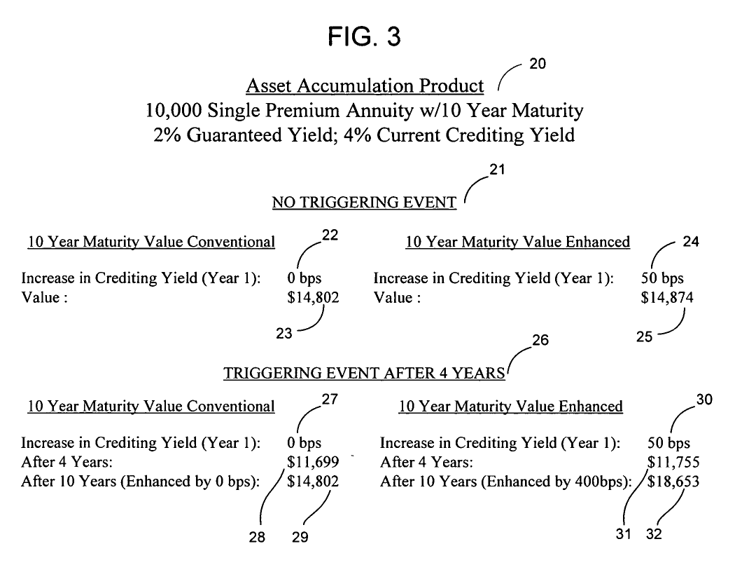

FIG. 3 illustrates a simplified example of an asset accumulation product 20 that compares the yield of the product in a first scenario 21, in which no triggering event occurs during the term of the product, and a second scenario 26, in which a triggering event occurs after four years into the term of the product. In this example, the product 20 is a ten thousand dollar ($10,000) single premium annuity with a ten-year maturity. The annuity further provides for a two percent (2%) guaranteed yield and, based upon hypothetical conditions, a “current” crediting yield of four percent (4%). This example is simplified for purposes of illustration and may not represent the performance of an actual annuity.

In each scenario, the enhanced yield rider offers an automatic enhancement of fifty basis points (50 bps) to the product's crediting yield in the first year of the term, see reference numerals 24 and 30. This enhancement is made regardless of the occurrence of a triggering event. In contrast, the conventional rider offers no enhancement to the yield of the product in the first year or otherwise, see reference numerals 22 and 27.

In the first scenario 21, the individual does not suffer a triggering event. The value of an asset accumulation product at maturity with a conventional rider will be $14,802, reference numeral 23, which value is calculated as the ten thousand dollar investment compounding at a four percent rate over a ten-year period. In contrast, the value of an asset accumulation product at maturity with an enhanced yield rider will be $14,874, reference numeral 25. This value is larger than the conventional value due to the added fifty basis points in the first year.

In the second scenario 26, the individual suffers a triggering event after four years into the product's term. For the conventional rider, which does not affect the yield of the product, the value of the asset accumulation product at maturity will be $14,802, reference numeral 29, which is the same as if no triggering event had occurred, reference numeral 23. In contrast, the value of an asset accumulation product at maturity with an enhanced yield rider will be $18,653, reference numeral 32. This value is calculated as the ten thousand dollar investment growing at a four and a half percent interest rate (four percent plus fifty basis points) for the first year of the term, followed by the investment compounding at a four percent rate for the next three years, followed by the investment compounding at an eight percent rate for the remaining six years. In this example, the enhanced yield rider increased the yield of the product for six years by 400 basis points.

As is readily appreciated, the enhanced yield rider can substantially increase the value of an asset accumulation product. Although the example of FIG. 3 does not illustrate the benefits paid from the conventional rider due to a triggering event, persons of skill in the art will recognize that an individual's wealth can be substantially increased, particularly when compared with a conventional rider, by increasing the yield of the product upon a triggering event. The magnitude of the increase may be further increased depending on the tax code of the investor's governing jurisdiction.

It will be apparent that further modifications may be made to the invention, and that some or all of the advantages of the invention may be obtained. Also, the invention is not intended to require each of the above-described features and aspects or combinations thereof. In many instances, certain features and aspects are not essential for practicing other features and aspects. The invention should only be limited by the appended claims and equivalents thereof, since the claims are intended to cover other variations and modifications even though not within their literal scope.

What we claim is:

1. A method for issuing an investment, the method comprising the steps of:
issuing an asset accumulation product to an individual in exchange for payment of at least one base premium, wherein the product returns a base yield to the individual at its maturity, and
issuing an insurance rider to the individual in exchange for payment of at least one rider premium, wherein the insurance rider guarantees an increase to the base yield of the product upon the occurrence of a predetermined event.

2. The method of claim 1, wherein the base yield is variable.

3. The method of claim 1, wherein the increase to the base yield ranges from between three hundred to five hundred basis points.

4. The method of claim 1, wherein the predetermined event is an accidental death of an individual.

5. The method of claim 1, wherein the predetermined event is selected from the group consisting of an individual's accidental death or dismemberment, an illness of predetermined severity, and the disability to perform a predetermined occupation.

6. The method of claim 1, wherein the rider premium is at least ten times lower than the base premium.

7. The method of claim 1, wherein the insurance policy further guarantees payment of a lump sum benefit upon the occurrence of the predetermined event.

8. The method of claim 1 further comprising the step of increasing the base yield independently of whether the predetermined event occurs.

9. The method of claim 8, wherein the independent increase ranges from between ten to sixty basis points.

10. A method for issuing financial instruments, the method comprising the steps of issuing an asset accumulation product, which product returns a yield on an investment, and issuing a rider that guarantees an increase to the yield on the investment by a predetermined amount upon the occurrence of a predetermined event.

11. The method of claim 10, wherein the increase to the yield on the investment ranges from between three hundred to five hundred basis points.

12. The method of claim 10, wherein the predetermined event is selected from the group consisting of an individual's accidental death or dismemberment, an illness of predetermined severity, and the disability to perform a predetermined occupation.

13. The method of claim 10, further comprising the step of increasing the yield on the investment for a predetermined period of time independently of whether the predetermined event occurs.

14. An insurance rider associated with an asset accumulation product, which product returns a yield on an investment, the rider comprising a guarantee to increase the yield on the investment by a predetermined amount upon the occurrence of a predetermined event.

15. The insurance rider of claim 14, wherein the predetermined amount is variable.

16. The insurance rider of claim 14, wherein the predetermined amount ranges from between three hundred to five hundred basis points.

17. The insurance rider of claim 14, wherein the predetermined event is an accidental death of an individual.

18. The insurance rider of claim 14, wherein the predetermined event is selected from the group consisting of an individual's accidental death or dismemberment, an illness of predetermined severity, and the disability to perform a predetermined occupation.

19. The insurance rider of claim 14, wherein the rider further guarantees payment of a lump sum benefit upon the occurrence of the predetermined event.

20. The insurance rider of claim 14, wherein the rider further guarantees payment of an increased yield on the investment for a predetermined period of time independently of whether the predetermined event occurs.
